(19) United States
(12) Patent Application Publication
(10) Pub. No.: US 2016/0283517 A1
(43) Pub. Date: Sep. 29, 2016

(54) Real Estate Data Gathering System and Method

(71) Applicants: Stephen M. Polston, Excelsior, MN (US); Jeffery Matthew Colville, Maple Grove, MN (US); Michelle Patrice Hiller, Elk River, MN (US); Daniel Scott Cowman, Andover, MN (US); Hector Meneses Hernandez, Plymouth, MN (US)

(72) Inventors: Stephen M. Polston, Excelsior, MN (US); Jeffery Matthew Colville, Maple Grove, MN (US); Michelle Patrice Hiller, Elk River, MN (US); Daniel Scott Cowman, Andover, MN (US); Hector Meneses Hernandez, Plymouth, MN (US)

(73) Assignee: PREFERRED HOME BUYERS NETWORK, INC., Excelsior, MN (US)

(21) Appl. No.: 15/078,254

(22) Filed: Mar. 23, 2016

Related U.S. Application Data
(60) Provisional application No. 62/136,794, filed on Mar. 23, 2015.

(51) Int. Cl. G06F 17/30

(52) U.S. Cl. CPC G06F 17/30241; G06Q 50/16

(57) ABSTRACT

A computerized system and method uses a central server to aggregate data from a plurality of data sources and presents such data to potential property purchasers. Users are assigned a dedicated e-mail address that is associated with their user account at the central server. Users can then review unaffiliated property search websites to discover information about a property. Using the sharing mechanism built into the property search website, an e-mail identifying the property is sent to the dedicated e-mail address. This e-mail may contain user comments or other useful data from the property search website A server receives the e-mail, identifies the property from the e-mail, extracts information from the e-mail, and stores this information in a central database. The property identifier can be used to extract additional information from other locations. Users can then view aggregated data through a user interface presented by the central server.

### FIELD OF THE INVENTION

This application relates to the field of automated systems that assist potential homebuyers who are searching for available properties. More particularly, the described embodiments provide a system and method for gathering information concerning properties from a plurality of data sources in order to present an aggregated view of such data to potential property purchasers.

### SUMMARY

Potential homebuyers have many resources available to them over the Internet. Numerous websites created by real estate agencies provide the ability to search for available properties. In many cases, these web sites include not only properties listed through the agency, but also properties listed by other agencies. Data concerning these properties is made available through a multiple listings service (or “MLS”). Multiple listing services allow agencies to discover most or all of the homes that are for sale in a particular geographic area. Agreements between the agencies and the MLSs allow the agencies to share MLS data with potential clients over an agency's consumer-facing website. In some cases, these agreements do not allow all of the MLS data to be share in this fashion. In addition, many agencies have information about properties that are not shared with other agencies or even with the local MLS. For instance, a listing agent may have access to greater detail about a property than is shared with MLS, meaning that the listing agent's website will be able to provide information about that property that is unavailable through a competitor's website. Furthermore, some data aggregators may create or discover custom data about properties that is available to consumers only through the aggregator's own website. For instance, several competing companies use proprietary algorithms to estimate a home's value. Consumers wishing to access this estimated value need to do so through the website of the company that developed this information. As a result, potential homebuyers frequently need to access multiple websites in order to discover all of the useful information about a property that is currently available over the Internet.

One embodiment of the present invention overcomes this issue by creating a central database of information concerning real estate properties. These properties may be currently for sale, recently sold, in the foreclosure process, or otherwise. Users establish an account with a centralized server that maintains the central database. Associated with this account is a dedicated e-mail address for that user. Users can then review properties information found on third-party property searching websites. When these websites provide a link to “e-mail a friend” about this property, the user can click on that link and instruct that the e-mail containing information about the property be sent to the dedicated e-mail address associated with their account on the centralized server.

When the server receives this e-mail, the server will examine the content of the e-mail in order to identify the property. The e-mail content is also examined for other information about the property, which is then extracted from the e-mail and added to the property data maintained by the server. Since the centralized server was able to identify the property, the server can use this identity information to query other servers for information about the property. For example, the centralized server may query an MLS database or a government properties database. In some embodiments, the centralized server uses an application programming interface to access the third-party property searching website that sent the e-mail, and is thereby able to acquire additional information about the property.

When the user returns to the centralized server (such as by using a web interface), the server will present to the user all of the information about the property that it has acquired. Additional information received directly from the user, such as a ranking value or user comments, can also be added through this web interface and stored in the central database along with the other property information.

### BRIEF DESCRIPTION OF THE DRAWINGS

FIG. 1 is a block diagram showing a centralized server with a central database communicating with one or more servers over a network.

FIG. 2 is a flow chart showing a method of implementing one embodiment of the present invention.

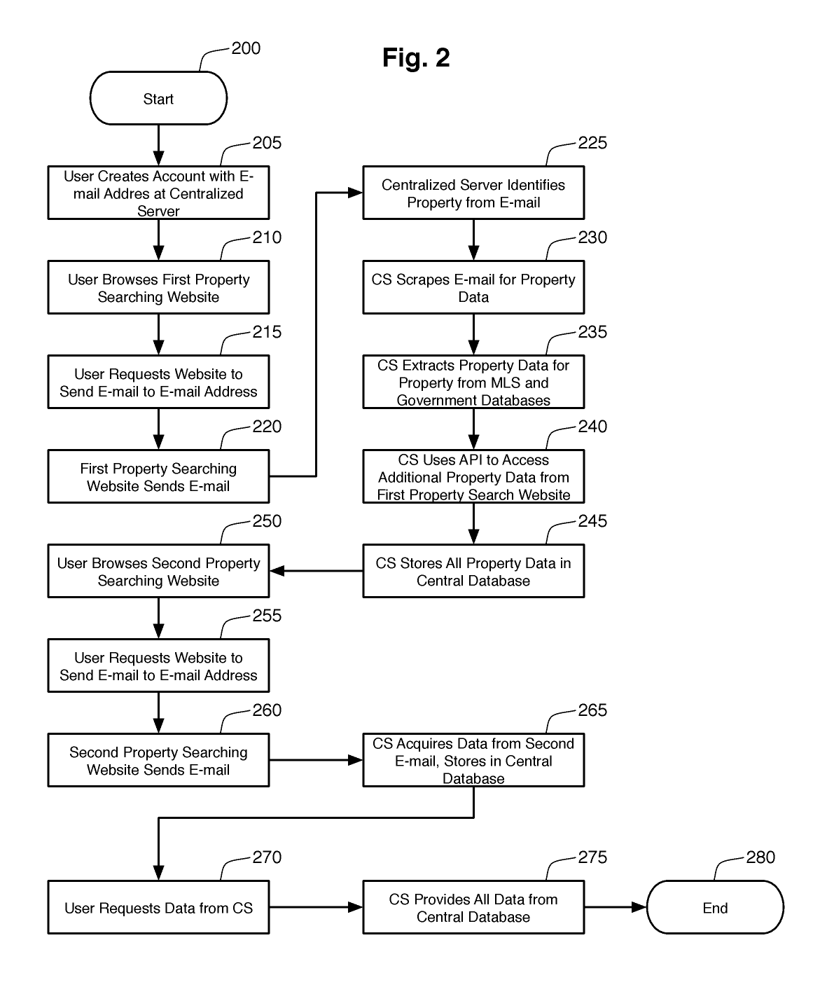

FIG. 3 is a schematic diagram showing the data generated and maintained within the central database.

### DETAILED DESCRIPTION

### Environment

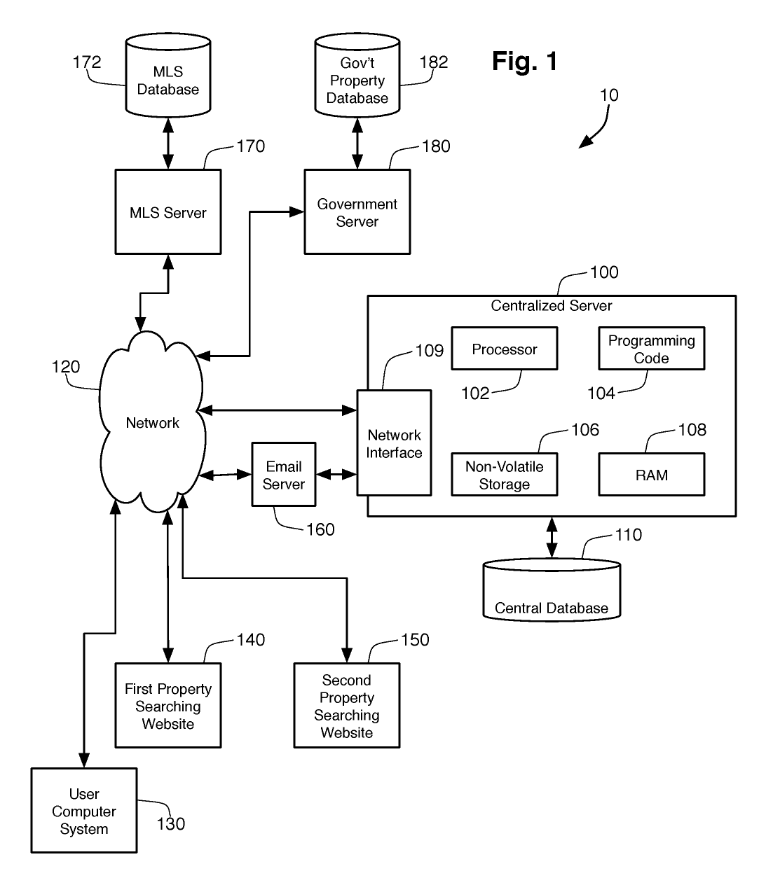

FIG. 1 is a block diagram of a system 10 that implements one embodiment of the present invention. A centralized server 100 stores data concerning users and properties in a central database 110. To access and manage the data in the database 110, the centralized server 100 uses a digital processor 102 that is under the control of software programming code 104. In one embodiment, the processor 102 is a microprocessor manufactured by Intel Corporation of Santa Clara, Calif., or Advanced Micro Devices, Inc. of Sunnyvale, Calif. The programming code 104 consists of a set of instructions and interfaces for execution on this digital processor 102. The programming code 104 is generally stored on non-volatile computer storage 106, such as a hard drive, RAM, PROM, flash memory, or some other form of non-volatile, physical memory. As is the case with most computing systems, the centralized server 100 can operate most efficiently if the programming code 104 is relocated during runtime from the non-volatile storage 106 and into random access memory 108. The combination of non-volatile storage 106 and RAM 108 can be collectively referred to as simply memory or storage. Although the centralized server 100 is shown in FIG. 1 as a single computer with a single processor 102, the server 100 could be implemented as a network of computers all operating according to the instructions of the computer programming code 104. The centralized server 100 uses a network interface 109 to communicate over a network 120 with other computing devices. In one embodiment, the network 120 is the Internet, and the network interface 109 includes TCP/IP protocol stacks for communicating over the network 120. The network interface 109 may connect to the network 120 wirelessly or through a physical wired connection.

The centralized server 100 is designed to communicate with, and provide property data to, a user using a user computer system 130. If the user computer system 130 is a personal computer running a computer operating system such as MAC OS (from Apple Inc. of Cupertino, Calif.) or WINDOWS operating system (from Microsoft Corporation of Redmond, Wash.), the user computer system 130 will likely use a web browser to communicate with a web server operating on the centralized server 100. In other cases, the user computer system 130 may be a mobile device operating a mobile-device-oriented operating system such as iOS (from Apple Inc.), WINDOWS PHONE (from Microsoft Corporation), or ANDROID (from Google Inc. of Menlo Park, Calif.). In these cases, the user computer system 130 may use either a web browser or a specialized application (or “app”) that communicates directly with the centralized server 100. One of the major differences between these two embodiments is that the web server provides the entire user interface to the web browser, while the applications or apps may implement much of the user interface locally and then use the dedicated data server to populate the interface with data appropriate for the user. In other cases, the applications or apps provide only a portion of the user interface, with the centralized server 100 implementing much of the user interface in effectively the same manner as a web server.

The user computer system 130 is also able to access other computing devices over the network 120, such as a first property searching website 140 and a second property searching website 150. These websites 140, 150 provide user interfaces to the user of the user computer system 130. The user accesses property data through these interfaces, which allows the user to search for and access information about properties that may be for sale. For example, the user may use their user computer system 130 to access the first property searching website 140 to search for homes that are for sale in their neighborhood. The first property searching website 140 may be provided by a real estate agency, which may provide information concerning the properties that they list through their website 140. In most cases, a real estate agency's website 140 will contain information not only about the properties that they list, but also about other properties that are listed in the same area through other agencies. This information is usually made available through arrangements with a local multiple listing service (or MLS). The MLS makes property listings available to the real estate agency so that information about these properties can be searched for and researched alongside the agency's own properties on the agency's website 140. It is possible that the agency will have more information about the properties that they list than is available through the MLS. As a result, the first property searching website 140 may contain information about the sponsoring agency's listings that cannot be found on any other website.

The second property searching website 150 may be provided by a competitive real estate agency. Alternatively, this website 150 may be provided by a national real estate aggregator, or another national real estate service provider, such as Trulia (San Francisco, Calif.). In some cases, the second website 150 may provide estimated values for properties, such as the values available at Zillow (a service provided by Zillow, Inc. of Seattle, Wash.). It is to be expected that these websites 150 will also contain data that is available only at that website 150.

Using the centralized server 100, a user can aggregate data from multiple websites 140, 150 into a single central database 110. In one embodiment, this is accomplished using e-mail links or services provided by the websites 140, 150. In many cases, these websites 140, 150 allows users to share information about a property that they view on the website with other parties. For example, a website may allow users to e-mail information about the property to other viewers, to send viewers a text message, or to share information about the property through a social networking service such as Facebook (from Facebook, Inc., of Menlo Park, Calif.), Google Plus (from Google Inc. of Menlo Park, Calif.), or Twitter (from Twitter, Inc., San Francisco, Calif.).

The centralized server 100 takes advantage of these sharing features by providing every user of the server 100 with a dedicated e-mail address. A user that is viewing information on other websites 140, 150 can spot a property that they like and, using the sharing feature provided by that website, send an e-mail to their dedicated e-mail address provided by the centralized server 100. The centralized server 100 utilizes an email server 160 to receive these e-mail messages. In other embodiments, the centralized server 100 itself provides the e-mail server capabilities and an external e-mail server 160 is not needed.

When the centralized server 100 receives this e-mail, the server 100 will examine the content of the e-mail in order to identify the property. For example, the e-mail content may include the street address of the property, or an identification number from the local MLS. Once the property is identified, a record for this property will be associated with the user inside the central database 110. If the property had been previously identified by this or another user, a data record for this property should already exist in the central database 110. If not, the centralized server 100 may create a new property record for the property in the database 110. In other embodiments, the central database 110 may be preconfigured with data records and summary data for all properties in a geographic area. The e-mail content is also examined for other information about the property. This information may be a description of the property, comments provided by the user through the third-party website, general information about the property available through the MLS, or proprietary information about the property created by the third-party website (such as a proprietary estimate of the property's value). This information is extracted from the e-mail and added to the property data.

The centralized server will also use the property identifier (such as the MLS number and street address) to obtaining additional information about the property. For instance, the centralized server 100 may submit a query over the network 120 to an MLS data server 170 or a government properties database server 180 to obtain additional information. Each of these servers 170, 180 contains or accesses a specialized property database 172, 182, respectively, that contains information that may be of interest to a user. For instance, the MLS database 172 may contain additional information about the property that was not made available by the sponsoring real estate agency that provided the first property searching website 140. The government property database 182 may, for example, provide property tax history data for the property. The centralized server 100 queries these servers 170, 180 and extracts relevant information from the response to these queries. This relevant information is stored in the central database 110 so that it can be retrieved whenever a user requests information from the centralized server 100 about that property.

The centralized server 100 may also access the first property searching website 140 or the second property searching website 150 for additional information about the property. In one embodiment, the centralized server 100 uses an application programming interface (or API) to access these websites 140, 150, in much the same manner as the centralized server 100 queries databases 172, 182. The additional property information that is gleaned about this property is also stored in the central database 110.

When the user then uses their user computer system 130 to log into the centralized server 100, the server 100 will present to the user all of the information about the property that it has acquired. This information may include data scraped from e-mails sent by user request from the first and second property searching websites 140, 150, data retrieved from third party servers 170, 180, and data obtained through an API to the property searching websites 140, 150. This information is typically presented to the user by either providing a web page interface to a browser operating on the user computer system 130, or through an interface provided by a custom app operating on the user's mobile device 130. These interfaces allow the user to browse through the aggregated information stored in the central database 100, and also to comment on the properties, rank the properties, and share information about the properties with their friends through e-mail or social media.

### Method 200

The computerized system 10 uses a method such as method 200 to provide aggregated property data to its users. The method 200 begins at step 205, in which a user creates an account at the centralized server 100. This account generally requires a username and a password in order to ensure that the user can protect their privacy as they gather and create information about properties of interest to them. In addition, the account set-up will also assign to the user a dedicated e-mail address for their use.

At step 210, the user begins to browse a third-party website such as the first property searching website 140. When the user spots a property that is of interest to them, the user requests that the website 140 send an e-mail message to their dedicated e-mail address concerning this property (step 215). In most cases, the third-party property websites provide a built-in functionality for sharing property information with others via e-mail, so this message is easily created and sent using the facilities of that website. The website 140 then sends the requested e-mail to the dedicated e-mail address in step 220. Alternatively, the website 140 may direct an e-mail application operating on the user computer 130 to send a pre-populated e-mail message to the dedicated e-mail address.

At step 225, the centralized server 100 recognizes that an e-mail from the first property searching website 140 has been received (perhaps through e-mail server 160) at the e-mail address dedicated to the user. The centralized server 100 then analyzes the content of that e-mail (including the e-mail's subject line) in order to identify the property. For example, the e-mail may contain the street address for the property, or the MLS number used to identify the property in the data maintained by the local multiple listing service. Once the property is identified, the centralized server 100 can identify the appropriate property record in the central database 110. In some embodiments, the central database 110 may be pre-populated with records for most or all properties within a specified geographic area. In other embodiments, the central database 110 starts empty, and creates new records as required by its customers. If the identified property does not already have a record in the central database 110, the centralized server 100 will create such a record once an e-mail identifying that property has been received.

The centralized server 100 will also examine the content of the received e-mail message for any additional information about the property included in that e-mail. Because these e-mails are consistently formatted, the centralized server 100 will be aware how the sending website 140 formats their e-mail. If useful information is included in this e-mail, the centralized server 100 will scrape this information for inclusion in the central database 110 at step 230. This information may include information about the property that is available only from the first property searching website 140, such as a proprietary estimate of the value of the home, comments made by the user at the first property searching website 140, or other property information unique to this website. By scraping this information from the e-mail, the centralized server 100 can supplement the data in its central database 110 with this unique information.

In some embodiments, the e-mail sent at step 220 will contain only a link to a particular page on the first property searching website 140. As a result, the centralized server 100 cannot scrape the e-mail to identify the property in step 225 or to obtain additional property data in step 230. In these circumstances, the centralized server 100 is programmed to follow the link included in the e-mail and examine the resulting web page presented by the first property searching website 140. The centralized server 100 will have stored information about the formatting of this web page, and therefore can use this information to scrape the page. In this manner, the centralized server 100 obtains the property identifier and the additional property information (steps 225 and 230) by scraping the linked-to web page as opposed to scraping the received e-mail.

The centralized server 100 will also use the property identifier to submit queries to external sources of information, such as the MLS server 170 and the government server 180. This is accomplished in step 235, and allows the centralized server 100 to receive additional information about the property from these servers 170, 180 and add this information into the central database 110.

In many instances, the first property searching website 140 that sent the e-mail in step 220 will provide an application programming interface to allow third parties to query their database. In most cases, use of this API will be subject to an agreement with the sponsor of the first property searching website 140. Assuming that such an agreement has been reached, the centralized server 100 will use this API to query the first property searching website 140 at step 240 in order to receive additional information about the property. All of the information gathered by the centralized server 100 in steps 230-240 will then be saved in the central database 110 in step 245.

At this point, the user may be browsing a second property searching website 150 at step 250. As explained above, the second property searching website 150 may be a website created by a real estate agency, or may be a national real estate site such as Zillow or Trulia. While reviewing this site 150, the user may request that information about a site be “shared” with a fried via e-mail or social media. Using built-in functionality provided by the website 150, the user can request that the website 150 send an e-mail to their dedicated e-mail address at the centralized server 100 (step 255). The second property searching website 150 will then, at step 260, send the e-mail to the user's dedicated e-mail address. The centralized server 100 receives this e-mail and then extracts identifying information for the property from the e-mail. Assuming that the e-mail sent at step 260 from the second property searching website 150 relates to the same property as the e-mail sent at step 220 from the first property searching website 140, the centralized server 100 will identify the record for that property and user the second e-mail to supplement its information concerning that property. For instance, the centralized server 100 may scrape the second e-mail for additional information or user comments, and then may connect to the second property searching website 150 via an API to obtain even more information about this property. This information is then added to the central database in step 265. If the e-mail from the second property searching website 150 relates to a new property, the centralized server 100 will identify the appropriate record in the central database 110 for this property (or create a new record if necessary), and then extract information from the e-mail, from the second property searching website 150 (using the website's API), and from the MLS server 170 and government servers 180, as was described in connection with the first property searching website 140 at steps 225-245.

At step 270, the user logs into the centralized server 100 and requests information about the properties that they have identified. The properties tracked by the centralized server 100 for the user may include only those properties identified through the e-mails from the first and second property searching websites 140, 150. However, it is also possible for a user to directly identify additional properties through the user interface provided by centralized server 100. At step 275, the centralized server 100 gathers the relevant information about these properties from its central database 110, and presents this information to the user through a computerized user interface. The method then stops at step 280.

### Central Database 110

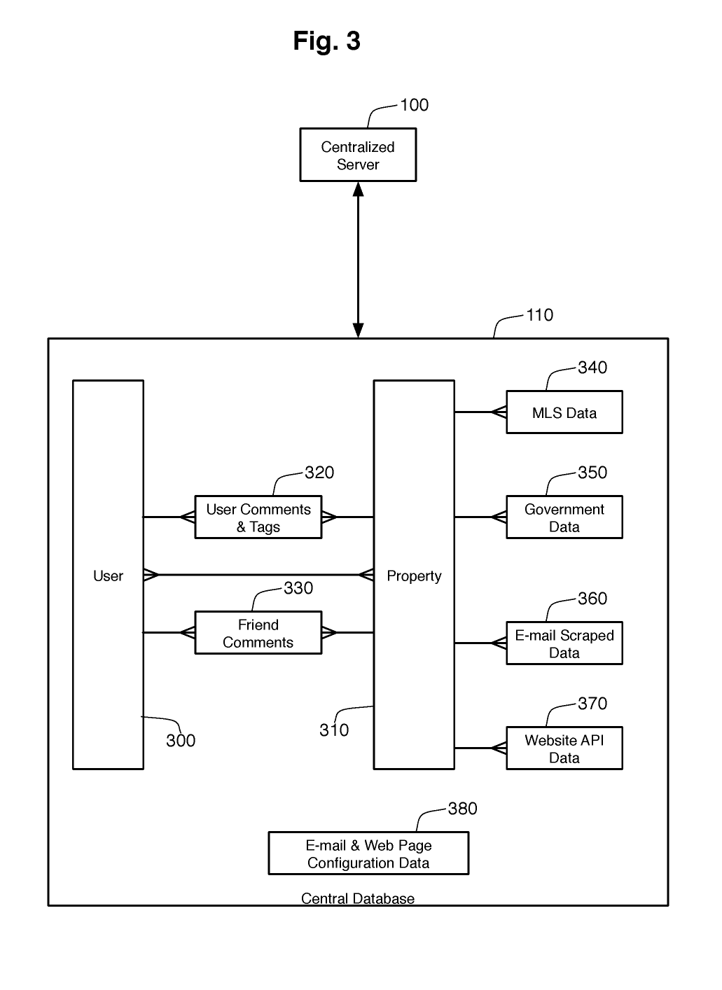

FIG. 3 is a schematic representation of the type of data stored in the central database 110. The data shown in FIG. 3 can be stored in tables in a relational database management system, or as objects in an object oriented database system. In fact, the data can be stored in any type of data structure. For ease in describing the various embodiments here, data in the database may be referred to as a data “record” that is linked to another data “record.” Nonetheless, neither this language nor the particular way in which the elements of FIG. 3 are drawn should be considered to define a particular type of data structure. Rather, this description merely shows the types of data stored in the database 110 and the relationships between these data elements. Relationships are shown in FIG. 3 in crow's foot notation, but this representation should not be construed to establish a particular type of database construction. For instance, user data 300 and property data 310 are associated with each other in a many-to-many relationship. This association could be established, for example, using key fields in a relational database or with pointers in an object oriented database.

The database 110 tracks information about particular users 300, including demographic information, contact information, username, and password. As mentioned above, each user 300 can be related to one or more properties 310 in the database 110, and each database can be associated with one or more users 300. In this way, the database 110 allows users to establish a personal list of properties (such as a “favorites” list). In the preferred embodiment, the centralized server 100 has access to all properties currently for sale in a geographic area. This data can be accessed through an agreement with a local MLS, or through other mechanisms. Data for all properties 310 can be stored in the central database 110. Alternatively, this all-properties data can be stored in a separate database accessible to the centralized server 100, and the central database 110 can limit itself to properties 310 specifically identified as being of interest to a user 300. Users can select properties either by searching the all-properties data made available through the centralized server 100, or by sending e-mail messages from property searching websites 140, 150.

The database 110 allows a user 300 to create comments (“I love the kitchen”) or tags (“near mother”) in database element 320. This data 320 is associated with a user 300 and an individual property 310, and is useful as the user tracks and organizes the properties 310 in their personal list. In the preferred embodiment, the centralized server 100 allows a user to share information about their properties with friends (much like the e-mail sharing described above in connection with websites 140, 150). These sharing messages will typically invite the friend to access the property information at the centralized server 100, and to provide comments that may assist the user in their selection of a home. These comments 330 are stored in the database 110 associated with the user/friend 300 and the particular property 310.

As explained above, the centralized server 100 can obtain information about a property 310 from a variety of sources. In FIG. 3, these sources of data are separately identified, namely MLS data 340 (obtained from server 170), government data 350 (obtained from government server 180), e-mail scrapped data (obtained directly from the e-mails sent at step 220 and 260 or by scraping a linked-to webpage identified within the e-mails), and website API data 370 (obtained by direct access to the data in the first and second property searching websites 140, 150). While FIG. 3 shows this information 340, 350, 360, 370 as being separately maintained in the database 110, it is likely that this information will be merged together and otherwise reorganized as necessary to create a complete data record for the property 310. Also note that the e-mail scraped data 360 and the website API data 370 may include user comments and tags 320 that the user created through websites 140, 150. This information, once identified, could be stored with the user comments and tags 320 created by the user for this property 310 through the user interface provided by the centralized server 100.

FIG. 3 shows the central database 110 also containing e-mail and web page configuration data 380. This data 380 contains information concerning the format used for the e-mails received from the first and second property searching websites 140, 150, or for the web page linked to by the e-mail. Using this information 380, the centralized server 100 is able to identify properties and scrape information concerning the properties in step 225 and 230. Because such e-mails and web pages are formatted consistently, the ability to store this formatting information 380 in the database greatly simplifies these tasks 225, 230.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A server comprising:
a) a processor that processes programming instructions;
b) non-transitory computer readable memory containing data in a database, the database comprising:
i) user data,
ii) property data, and
iii) user property comments data; and
c) non-transitory computer readable memory containing programming for the processor causing the processor to:
i) receive a first e-mail concerning a property generated by a first property searching website,
ii) recall first e-mail configuration data describing formatting for the first e-mail from the first property searching website,
iii) extract a property identifier and first website property information from the first e-mail using the first e-mail configuration data,
iv) store the first website property information in association with the property data for the property in the database,
v) use the property identifier to query an external source of property information and to receive a response to the query, and
vi) store data received in the response to the query in association with the property data for the property in the database.

2. The server of claim 1, wherein the programming further causes the processor to present the first website property information and the data received in response to the query to a user through a user interface.

3. The server of claim 2, wherein the programming further causes the processor to register the user through the user interface and create a user record for the user in the user data of the database, wherein the registering of the user associates the user record with a user-dedicated e-mail address.

4. The server of claim 3, wherein the first e-mail is received at the user-dedicated e-mail address, and further wherein the user record associated with the user-dedicated e-mail address is automatically associated with a property record in the property data that contains data about the property identified from the first e-mail.

5. The server of claim 4, wherein the external source of property information is a multiple listing service database.

6. The server of claim 4, wherein the external source of property information is a government database containing property tax information.

7. The server of claim 4, wherein the programming further causes the processor to extract user comments from the first e-mail and to store the user comments in the user property comments data in the database.

8. The server of claim 7, wherein the user interface provides an ability to add user property comments data to the database.

9. The server of claim 8, wherein the added user property comments data is combined with the extracted user comments from the first e-mail in the user interface.

10. The server of claim 4, wherein the programming for the processor further causes the processor to:
vii) receive, at the user-dedicated e-mail address, a second e-mail concerning the property generated by a second property searching website,
viii) recall second e-mail configuration data describing formatting for the second e-mail from the second property searching website,
ix) extract second website property information from the second e-mail using the second e-mail configuration data,
x) store the second website property information in association with the property data for that property in the database,
xi) present the second website property information along with the first website property information and the data received in response to the query through the user interface.

11. The server of claim 4, wherein the programming further causes the processor to:
vii) query the first property searching website using an application programming interface to request information about the property and storing response data in association with the property data for the property in the database, and
viii) present, through the user interface, data received in response to the first property searching website query along with the first website property information extracted from the first e-mail and the data received in response to the external source query.

12. A computer implemented method operating on a computerized server comprising:
a) at the computerized server, receiving user information through a user interface from a remote user and storing the user information in a computerized database;
b) at the computerized server, associating the user information in the computerized database with a user-dedicated e-mail address that was disclosed to the remote user through the user interface;
c) at the computerized server, receiving a first e-mail addressed to the user-dedicated e-mail address, the first e-mail being generated by a first website and relating to a property;
d) at the computerized server, recalling first e-mail configuration data describing formatting for the first e-mail from the first website;
e) at the computerized server, extracting first website property information from the first e-mail using the first e-mail configuration data;
f) at the computerized server, storing the first website property information in the computerized database; and
g) at the computerized server, presenting the first website property information from the computerized database to the remote user.

13. The computerized method of claim 12, further comprising:
h) at the computerized server, extracting a property identifier from the first e-mail using the first e-mail configuration data;
i) at the computerized server, using the property identifier to query an external source of property information and to receive a response to the query;
j) at the computerized server, storing data received in the response to the query in the computerized database;
k) at the computerized server, presenting the stored data received in the response along with the first website property information to the remote user.

14. The computerized method of claim 13, wherein the external source of property information is a multiple listing service database.

15. The computerized method of claim 13, wherein the external source of property information is a government database containing property tax information.

16. The computerized method of claim 13, wherein the first website property information comprises user comments input by the remote user at the first website.

17. The computerized method of claim 16, wherein the user interface provides an ability to add user property comments data to the computerized database.

18. The computerized method of claim 17, wherein the added user property comments data are combined with the extracted user comments from the first e-mail in the user interface.

19. The computerized method of claim 13, further comprising:
l) at the computerized server, receiving a second e-mail addressed to the user-dedicated e-mail address, the second e-mail being generated by a second website and relating to the property;
m) at the computerized server, recalling second e-mail configuration data describing formatting for the second e-mail from the second website;
n) at the computerized server, extracting second website property information from the second e-mail using the second e-mail configuration data;
o) at the computerized server, storing the second website property information in the computerized database; and
p) at the computerized server, presenting the second website property information along with the first website property information and the stored data received in the response through the user interface.

20. The computerized method of claim 13, further comprising:
l) at the computerized server, querying the first website using an application programming interface to request information about the property and storing response data in the computerized database; and
m) at the computerized server, presenting, through the user interface, data received in response to the first website query along with the first website property information extracted from the first e-mail and the data received in response to the external source query.
